(19) United States
(12) Patent Application Publication
(10) Pub. No.: US 2015/0090003 A1
(43) Pub. Date: Apr. 2, 2015

(54) POSRV PERFORMANCE EVALUATION TEST APPARATUS AND CONTROL SYSTEM OF THE SAME

(71) Applicant: M&D CO., LTD., Suwon-si (KR)

(72) Inventors: Myeong Jin LEE, Seoul (KR); Jang Bom Chai, Seoul (KR); Ho Geun Ryu, Daejeon (KR); Hoon Jang, Daejeon (KR); Dong Soo Kim, Daejeon (KR)

(73) Assignee: M&D CO., LTD., Suwon-si (KR)

(21) Appl. No.: 14/108,373

(22) Filed: Dec. 17, 2013

(30) Foreign Application Priority Data
Oct. 1, 2013 (KR) 10-2013-0117545
Oct. 1, 2013 (KR) 10-2013-0117546

(51) Int. Cl. F16K 37/00; G01N 3/12; G01L 7/00

(52) U.S. Cl. CPC F16K 37/0083; F16K 37/0091; G01L 7/00; G01N 3/12
USPC 73/37

(57) ABSTRACT

Disclosed are a pilot operated safety and relief valve (POSRV) performance evaluation test apparatus, which can test performance evaluation of a POSRV in a structurally stable state, and cope with various sizes of a lift cylinder or a spring-loaded pilot valve, and a control system of the POSRV performance evaluation test apparatus, which can prevent an inside of the lift cylinder from being suddenly pressed and thus damaged and at the same time more precisely evaluate the performance of the POSRV.

### CROSS-REFERENCE TO RELATED APPLICATION

This application claims priority to and the benefit of Korean Patent Application Nos. 10-2013-0117545 and 10-2013-0117546 filed in the Korean Intellectual Property Office on Oct. 1, 2013, respectively, the entire contents of which are incorporated herein by reference.

### BACKGROUND OF THE INVENTION

(a) Field of the Invention

The present invention relates to a pilot operated safety and relief valve (POSRV) performance evaluation test apparatus and a control system of the same, and more particularly to a POSRV performance evaluation test apparatus, which can test performance evaluation of a POSRV in a structurally stable state, and cope with various sizes of a lift cylinder or a spring-loaded pilot valve, and a control system of the POSRV performance evaluation test apparatus, which can prevent an inside of the lift cylinder from being suddenly pressed and thus damaged and at the same time more precisely evaluate the performance of the POSRV.

(b) Description of the Related Art

A pilot operated safety and relief valve (POSRV) is installed in an upper portion of a pressurizer of a nuclear power plant, and capable of performing a function of a safety valve and a safety depressurization function in a reactor coolant system of the nuclear power plant.

The POSRV includes combination of three valves. Specifically, the POSRV includes a main valve directly connected to an upper nozzle of the pressurizer and formed with an inlet and an outlet; a spring-loaded pilot valve for performing the function of the safety valve, and a motor-driving pilot valve for performing the safety depressurization function.

The spring-loaded pilot valve serves to protect components of the pressurizer and a reactor coolant system (RCS) with regard to an over pressure as the spring-loaded pilot valve is opened in a setting pressure in the same driving method as the safety valve and thus the main valve becomes open.

The motor-driving pilot valve serves to rapidly depressurize the RCS as it is opened by an electric signal so as to open the main valve, thereby introducing a coolant from the exterior and rapidly depressurizing the RCS at a design-reference accident.

Accordingly, it is very important to prove each performance of the spring-loaded pilot valve and the motor-driving pilot valve when the performance of the POSRV is evaluated.

A test apparatus for carrying out the performance evaluation of the POSRV has to acquire data for performing a setting pressure test as the function of the safety valve in the POSRV, and has to collect data acquired when an experiment on safety depressurization is made.

The setting pressure test for the function of the safety valve in the POSRV may be performed by two methods. In a first test method, a bench-set test apparatus is employed, in which the inlet of the main valve is tested by pressing non-compressible fluid up to the setting pressure with regard to whether it is opened at the setting pressure and whether it is closed at a re-closing pressure

In a second test method, a lifting device is connected to a spring stem of the spring-loaded pilot valve to use lifting force in order to test whether it is opened at the setting pressure of the POSRV and whether it is closed at the re-closing pressure.

In the first test method, the POSRV is disassembled in an upper portion of the pressurizer, the test is performed in the bench-set, and the non-compressible fluid is used as a test fluid and is therefore different from the fluid used while the nuclear power plant is in operation. Accordingly, it is difficult to accurately measure the setting pressure and the re-closing pressure of the POSRV.

On the other hand, in the second test method, the POSRV is not disassembled in the upper portion of the pressurizer, and the lifting device is directly installed in the POSRV to use a system pressure (i.e., use pressure) and the lifting force of the lifting device. Accordingly, this test method can more accurately measuring the setting pressure and the re-closing pressure of the POSRV than the first test method (using the bench-set test apparatus) and has an advantage of being convenient.

As the second test method, a conventional POSRV performance evaluation test apparatus for testing the setting pressure and the re-closing pressure through the pressure of the system and the lifting force of the lifting device will be schematically described as follows.

The conventional POSRV performance evaluation test apparatus is installed to an upper flange of the spring-loaded pilot valve or an upper end of a spring cover, and connected to a spring stem of the spring-loaded pilot valve, thereby testing the setting pressure of the POSRV.

In such a conventional POSRV performance evaluation test apparatus, if the internal pressure of the lift cylinder is gradually increased, force (i.e., lifting force) of lifting the spring stem of the spring-loaded pilot valve increases. Further, if the force of lifting the spring stem is continued, the spring-loaded pilot valve instantly becomes open and at this time pressure (i.e., lifting pressure) applied to the lift cylinder is measured, thereby calculating pressure difference (i.e., pressure obtained by subtracting the system pressure from the setting pressure).

Here, the setting pressure of the spring-loaded pilot valve corresponding to the safety valve is the sum of the calculated pressure difference and the system pressure (i.e., the use pressure), which can be calculated as follows: the setting pressure (Pset)=the pressure difference (psi)+Psystem (psi).

Here, if force of the spring installed in the spring-loaded pilot valve is Fspring, it can be expressed as follows.

Fspring=ASeat×PSet

Here, ASeat=the disk effective area (in²) of the spring-loaded pilot valve, and PSet=the setting pressure (psi) of the spring-loaded pilot valve.

Also, when the POSRV performance evaluation test apparatus is used, force is equilibrated as follows.

A spring setting value of the spring-loaded pilot valve=force based on the POSRV performance evaluation test apparatus+force based on the system pressure (i.e., use pressure).

$$\begin{matrix}That is , F spring = F system + F Assis t \\ = A Seat \times P system + A Cylinder \times P Cylinder\end{matrix}$$

$$\begin{matrix}Thus , the setting value ( P set ) = P system + ( A Cylinder \times P Cylinder ) / \\ A Seat \\ = P system + F Assist / A Seat \\ = the pressure difference + P system\end{matrix}$$

Where, Psystem: the pressure (psi) of the system where the spring-loaded pilot valve is installed, ACylinder: the effective area (in²) of the lift cylinder, PCylinder: the pressure (psi) of the lift cylinder, and FAssist: the lifting force of the POSRV performance evaluation test apparatus in order to instantly open the spring-loaded pilot valve.

Through this process, POSRV performance evaluation test apparatus is used to test whether the spring-loaded pilot valve is normally opened at the setting pressure and closed at the re-closing pressure.

The system pressure corresponds to an actual system pressure when the POSRV performance evaluation test apparatus is applied while the system is in operation, and corresponds to the use pressure when the system is not in operation, that is, when a certain system pressure is applied for experiment during a testing procedure.

Thus, in the conventional POSRV performance evaluation test apparatus, the lift cylinder internally formed with the disk is fixed to an upper portion of an upper plate. In result, a cylinder shell forming an outer appearance of the lift cylinder is supported by the upper plate in only its lower portion, but not supported at all in its upper portion.

Accordingly, when the pressure is applied to the inside of the lift cylinder, the pressure is applied toward an upper side within the cylinder shell, and thus only the upper side of the cylinder shell continuously receives force, thereby causing the cylinder shell to be vibrated. In result, it is impossible to accurately measure the internal pressure of the lift cylinder, and the calculated pressure difference becomes more inaccurate as time goes by.

Also, in the conventional POSRV performance evaluation test apparatus, a frame bar is always fixed for connection between a lower plate and the upper plate. Therefore, if there is a need for adjusting distance between the lift cylinder and the spring-loaded pilot valve (for example, if the size of the lift cylinder or the spring-loaded pilot valve is varied), the whole apparatus or the frame bar has to be replaced.

Meanwhile, in addition to such structural problems of the POSRV performance evaluation test apparatus, a system or method for driving and controlling the conventional POSRV performance evaluation test apparatus has another problem.

That is, the system or method for driving and controlling the POSRV performance evaluation test apparatus employs only the pressure of fluid or only the amount of fluid to quickly give the pressure when the internal pressure of the lift cylinder is pneumatically or hydraulically made, and therefore a problem arises in that the internal pressure of the lift cylinder is suddenly made.

Further, while only the pressure of fluid or only the amount of fluid is used to quickly give the pressure, the amount or pressure of fluid is not minutely adjusted (e.g., not minutely increased). Therefore, it is impossible to precisely measure the internal pressure of the lift cylinder and it is thus impossible to accurately determine whether the setting pressure is effective or not.

Consequently, a conventional system or method for controlling the POSRV performance evaluation test apparatus suddenly makes the internal pressure of the lift cylinder and does not minutely adjusts the amount or pressure of fluid. Therefore the lift cylinder and the spring-loaded pilot valve may be damaged, and it is thus impossible to accurately perform the performance evaluation of the POSRV.

### SUMMARY OF THE INVENTION

Accordingly, the present invention is conceived to solve the forgoing problems, and an aspect of the present invention is to provide a pilot operated safety and relief valve (POSRV) performance evaluation test apparatus, which can test performance evaluation of a POSRV in a structurally stable state, and cope with various sizes of a lift cylinder or a spring-loaded pilot valve, and a control system of the POSRV performance evaluation test apparatus, which can prevent an inside of the lift cylinder from being suddenly pressed and thus damaged and at the same time more precisely evaluate the performance of the POSRV.

In accordance with an aspect of the present invention, there is provided a pilot operated safety and relief valve (POSRV) performance evaluation test apparatus including: a lower plate which is installed in an upper portion of a spring-loaded pilot valve; an upper plate which is placed above and opposite in parallel to the lower plate; a frame bar which connects the lower plate and the upper plate; a lift cylinder which is fixed and attached to a bottom of the upper plate and includes an inner space where a disc is lifted by fluid introduced from an outside; and a lift stem which includes one end connected to a bottom of the disc and the other end vertically extended downward and connected to a spring stem of the spring-loaded pilot valve as being exposed to the outside of the lift cylinder.

The lift cylinder may include a coupling plate attached and coupled to the bottom of the upper plate, and a cylinder shell which includes an upper portion attached to the coupling plate to form the inner space, in which the disc is arranged at an upper side, a fluid inlet and a fluid outlet through which the fluid can be introduced and discharged at lateral lower sides, respectively, and a through hole to be penetrated by the lift stem on a bottom.

The frame bar may be coupled to the upper plate or the lower plate and movable up and down to adjust a distance between the upper plate and the lower plate.

The POSRV performance evaluation test apparatus may further include a linear variable differential transformer (LVDT) stem which is installed on a top of the disc and measures a vertical displacement of the disc.

The POSRV performance evaluation test apparatus may further include a load cell interposed and connected between the lift stem and the spring stem of the spring-loaded pilot valve.

In accordance with an aspect of the present invention, there is provided a control system of a pilot operated safety and relief valve (POSRV) performance evaluation test apparatus, the control system including: a fluid supplying device which supplies fluid into and applies pressure to a lift cylinder of the POSRV performance evaluation test apparatus by minutely adjusting only an amount of fluid while constantly maintaining a pressure of fluid or by minutely adjusting only the pressure of fluid while constantly maintaining the amount of fluid; a fluid discharging device which discharges the fluid from the lift cylinder of the POSRV performance evaluation test apparatus to depressurize the inside of the lift cylinder; and a control device which controls only one of the fluid supplying device and the fluid discharging device, in which the fluid supplying device is controlled to preferentially operate, and only the fluid discharging device is controlled to operate after controlling the fluid supplying device to stop operating when there is no change in a displacement value of the lift cylinder.

The fluid supplying device may include a fluid generator which generates and supplies the fluid; a regulator which regulates and effuses the fluid generated by the fluid generator to have a certain pressure; a pressure adjusting valve which maintains or minutely adjusts the regulated pressure of fluid to be effused; a supplying amount adjusting valve which maintains or minutely adjusts the amount of fluid introduced from the pressure adjusting valve and effused; and a supplying solenoid valve which controls the fluid introduced from the supplying amount adjusting valve to be supplied to the lift cylinder.

The fluid discharging device may include a discharging solenoid valve which controls the fluid to be discharged from the lift cylinder; and a discharging amount adjusting valve which adjusts the amount of fluid introduced from the discharging solenoid valve to be discharged.

The control device may control the pressure adjusting valve to effuse the fluid with a fixed pressure, and control the supplying amount adjusting valve to effuse the fluid with the fixed pressure while changing the amount of fluid until there is no change in a displacement value of the lift cylinder.

The control device may controls the supplying amount adjusting valve to effuse the introduced fluid with a fixed amount without changing the amount of fluid, and control the pressure adjusting valve to effuse the fluid introduced with a certain pressure while changing the pressure of fluid until there is no change in the displacement value of the lift cylinder.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a perspective view of a POSRV performance evaluation test apparatus to be controlled under a control system for the POSRV performance evaluation test apparatus according to an exemplary embodiment;

FIG. 2 is a partial perspective view of the POSRV performance evaluation test apparatus to be controlled under the control system for the POSRV performance evaluation test apparatus according to an exemplary embodiment;

FIG. 3 is a sectional view of the POSRV performance evaluation test apparatus to be controlled under the control system for the POSRV performance evaluation test apparatus according to an exemplary embodiment;

FIG. 4 is a schematic view of a system for testing a setting pressure through the POSRV performance evaluation test apparatus to be controlled under the control system for the POSRV performance evaluation test apparatus according to an exemplary embodiment;

FIG. 5 is a block diagram of the control system for the POSRV performance evaluation test apparatus according to an exemplary embodiment; and

FIG. 6 is a flowchart for explaining a control process of the POSRV performance evaluation test apparatus through the control system for the POSRV performance evaluation test apparatus according to an exemplary embodiment.

### DETAILED DESCRIPTION OF THE EMBODIMENTS

Below, exemplary embodiments of a pilot operated safety and relief valve (POSRV) performance evaluation test apparatus and a control system of the same about the foregoing problems, solutions and effects according to the present invention will be described with reference to accompanying drawings.

In the following, the size, shape or the like of elements shown in the drawings may be exaggerated for clarity of description and convenience. Also, terms specifically defined in consideration of the structure and function of the invention may be varied depending on a user, intention of an operator, or custom. The definition about such terms has to be based on contents throughout this specification.

The present invention relates to a control system of a POSRV performance evaluation test apparatus, and may be thus utilized as a system for controlling a conventional POSRV performance evaluation test apparatus having various structures.

First, a POSRV performance evaluation test apparatus to be controlled under the control system for the POSRV performance evaluation test apparatus according to the present invention will be described. That is, configurations, structures and operations of a POSRV performance evaluation test apparatus to be controlled under the control system for the POSRV performance evaluation test apparatus will be first described.

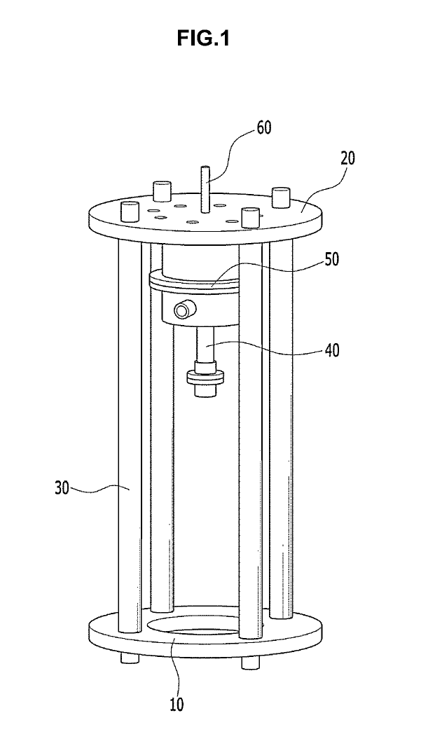

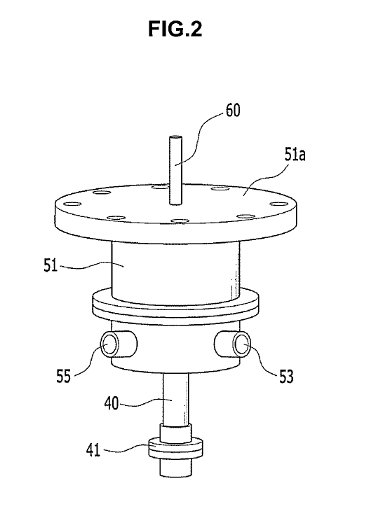

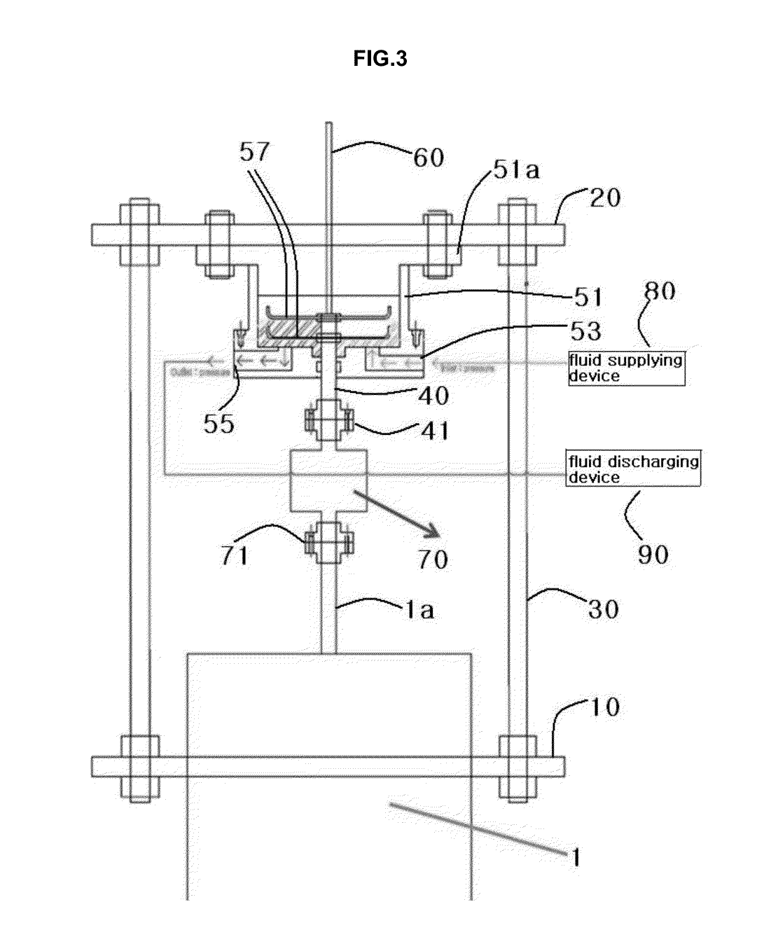

FIG. 1 is a perspective view of a POSRV performance evaluation test apparatus 100 to be controlled under a control system for the POSRV performance evaluation test apparatus according to an exemplary embodiment; FIG. 2 is a partial perspective view of the POSRV performance evaluation test apparatus 100 to be controlled under the control system for the POSRV performance evaluation test apparatus according to an exemplary embodiment; and FIG. 3 is a sectional view of the POSRV performance evaluation test apparatus 100 to be controlled under the control system for the POSRV performance evaluation test apparatus according to an exemplary embodiment.

As shown in FIGS. 1 to 3, a POSRV performance evaluation test apparatus according to an exemplary embodiment includes a lower plate 10, an upper plate 20, a frame bar 30, a lift stem 40 and a lift cylinder 50.

The lower plate 10 is attached and installed to an upper portion of the spring-loaded pilot valve 1. Specifically, the lower plate 10 is fixed and attached to a flange upper portion of a housing upper portion of the spring-loaded pilot valve 1.

As shown in FIGS. 1 to 3, the lower plate 10 is generally shaped like a disc, and formed with a through hole in the middle thereof so that the spring stem 1a of the spring-loaded pilot valve 1 can be vertically lifted.

Also, the lower plate 10 is formed with a coupling hole, to which a lower end of the frame bar 30 is coupled, along a circumferential portion thereof. In addition, a bolt coupling hole is formed to bolt-couple with a flange portion of the spring-loaded pilot valve 1.

The upper plate 20 is arranged above and spaced apart at a certain distance from the lower plate 10. That is, the upper plate 20 is arranged above and in parallel with the lower plate 10.

As shown in FIGS. 1 to 3, the upper plate 20 has a disc shape like the lower plate 10. Further, the upper plate 20 is formed with a coupling hole, to which the upper end of the frame bar 30 is coupled, along a circumference thereof.

Also, the upper plate 20 is formed with a bolt coupling hole so that the lift cylinder 50 can be fixed and attached on to a bottom thereof. That is, the lift cylinder 50 is stably fixed to the bottom of the upper plate 20 by bolt-coupling. The lower plate 10 and the upper plate 20 are connected to each other by the frame bar 30. That is, the frame bar 30 connects the lower plate 10 and the upper plate 20.

The frame bar 30 is interposed between the lower plate 10 and the upper plate 20 and arranged vertically. Here, an upper end of the frame bar 30 is coupled to the upper plate 20 and a lower end thereof is coupled to the lower plate 10.

Specifically, the upper end of the frame bar 30 is inserted in and coupled to the coupling hole formed along the circumference of the upper plate 20, and the lower end thereof is inserted in and coupled to the coupling hole formed along the circumference of the lower plate 10. The certain distance and stable state between the lower plate 10 and the upper plate 20 are maintained by the frame bar 30.

As shown in FIGS. 1 to 3, a plurality of frame bars 30 are respectively coupled to the coupling holes formed along each circumference of the lower plate 10 and the upper plate 20. FIGS. 1 to 3 illustrate that four frame bars 30 connect the lower plate 10 and the upper plate 20 with each other.

In an inner space partitioned by the plurality of frame bars 30, the lift cylinder 50 is fixed and coupled to the bottom of the upper plate 20. That is, the lift cylinder 50 is fixed and attached to the bottom of the upper plate 20. Thus, the lift cylinder 50 can be stably kept on the bottom of the upper plate 20 without being vibrated or shaken while the spring stem 1a is lifted by the lift cylinder 50. Consequently, it is possible to accurately measure the pressure applied to the lift cylinder 50.

As shown in FIGS. 1 to 3, the lift cylinder 50 is formed with an inner space in which a disc 57 to be lifted by a fluid introduced from the exterior is provided.

The lift cylinder 50 may be a type of a cylinder or a diaphragm, and the fluid introduced into the inner space of the lift cylinder 50 and lifting the disc 57 may include argon, nitrogen or the like gas, or oil. That is, the lift cylinder 50 may be pneumatically or hydraulically operated.

In the case of the diaphragm type, a disc effective area is changeable, but it is easy to prevent the fluid from leaking out. On the other hand, in the case of the cylinder type, the disc effective area is unchangeable, but it is hard to prevent the fluid from leaking out.

As shown in FIG. 3, the lift cylinder 50 includes a coupling plate 51a, a cylinder shell 51 and the disc 57. The coupling plate 51a is attached to an upper portion of the cylinder shell 51 forming the inner space, and the disc 57 is provided in the inner spaced of the cylinder shell 51.

Specifically, the coupling plate 51a is attached and coupled to the bottom of the upper plate 20, and is coupled to the upper portion of the cylinder shell 51, thereby sealing up the inner space of the cylinder shell. The coupling plate 51a is fixed and attached to the bottom of the upper plate 20 by the bolt-coupling.

As shown in FIGS. 1 to 3, the cylinder shell 51 is generally shaped like a cylinder. Further, the cylinder shell 51 forms the inner space while an upper portion thereof is attached to the coupling plate 51a.

The disc 57 is placed at an upper side within the inner space of the cylinder shell 51, and as shown in FIGS. 1 to 3, the cylinder shell 51 includes a fluid inlet 53 in which the fluid is introduced and a fluid outlet 55 from which the fluid is discharged at a lateral lower side thereof, and a through hole through which the lift stem 40 passes on a bottom thereof.

The lift stem 40 as shown in FIGS. 1 to 3 includes one end connected to the bottom of the disc 57 and the other end vertically extended downward and connected to the spring stem 1a of the spring-loaded pilot valve 1 as it is exposed to the outside of the lift cylinder 50.

The lift stem 40 is lifted as the disc 57 is lifted by the pressure of the fluid, so that the spring stem 1a connected to the lift stem 40 can be lifted upward and thus the spring-loaded pilot valve 1 can become open.

Because the lift stem 40 moves up and down through the through hole formed on the bottom of the cylinder shell 51, a gasket is provided in the through hole so as to prevent the fluid from leaking out.

With this configuration, the POSRV performance evaluation test apparatus controlled according to an exemplary embodiment is fixed and attached to the upper portion of the flange upper portion of the spring-loaded pilot valve 1 as described above. In this state, the disc 57 is lifted by the fluid introduced into the lift cylinder 50, so that the spring stem 1a connected to the lift stem 40 can be lifted upward.

In this process, the pressure in the inner space of the lift cylinder 50, the force acting on the lift stem 40, the displacement of the disc 57, etc. are measured to calculate the pressure difference for lifting the spring stem 1a and thus open the spring-loaded pilot valve 1. As described above, the pressure difference is obtained by subtracting the system pressure (i.e., use pressure) from the setting pressure of the spring-loaded pilot valve.

Using such a calculated pressure difference, it is possible to test whether the setting pressure of the spring-loaded pilot valve 1 is normally maintained, and thus possible to evaluate the performance of the POSRV.

For example, as described above, the setting pressure has to be equal to the sum of the system pressure (i.e., use pressure) and the pressure difference within an error range. Therefore, the pressure difference is calculated at the moment when the lift cylinder 50 opens the spring-loaded pilot valve 1, and it is possible to evaluate the performance of the spring-loaded pilot valve 1 and the performance of the POSRV including a main valve 2 connecting with the spring-loaded pilot valve 1.

Referring to FIG. 3, operations of the POSRV performance evaluation test apparatus controlled according to an exemplary embodiment and a process of evaluating the performance of the POSRV using the same will be schematically described as follows.

As shown in FIG. 3, the lift cylinder 50 receives fluid from a fluid supplying device 80 through a fluid inlet 53. The fluid supplying device 80 controls the amount and pressure of fluid and supplies the fluid to the lift cylinder 50 through the fluid inlet 53.

At this time, a fluid discharging device 90 does not allow the fluid to be discharged through the fluid outlet 55. For example, the fluid discharging device 90 includes various opening/closing valves and closes the opening/closing valves to thereby prevent the fluid from leaking out through the fluid outlet 55.

Then, the pressure of the fluid is applied to the disc 57 provided in the inner space of the lift cylinder 50, and the disc 57 is lifted by the pressure. The fluid supplying device 80 controls the pressure or amount of fluid and supplies it to the lift cylinder until as the disc 57 is lifted and the spring stem 1a connecting with the lift stem 40 is lifted upward to open the spring-loaded pilot valve 1.

At the moment when the spring-loaded pilot valve 1 is opened, a controller (not shown) receives various data such as the lifting force applied to the lift stem 40, the internal pressure of the lift cylinder 50, the displacement of the disc, etc. from various sensors provided in the POSRV performance evaluation test apparatus, and uses the sensed data to calculate the pressure difference due to the lifting force of the lift cylinder at the moment when the spring-loaded pilot valve 1 is opened.

In accordance with whether the sum of the calculated pressure difference and the system pressure (i.e., use pressure) is equal to the setting pressure of the spring-loaded pilot valve 1 within an error range, the performance evaluation of the spring-loaded pilot valve 1 can be performed.

Meanwhile, the POSRV performance evaluation test apparatus controlled according to an exemplary embodiment may evaluate whether the setting pressure is effective, and also evaluate whether the re-closing pressure of the spring-loaded pilot valve 1 is effective.

Specifically, when the spring-loaded pilot valve 1 is opened, the fluid supplying device 80 cuts off the fluid supplied through the fluid inlet 53, and the fluid discharging device 90 allows the fluid to be discharged from the lift cylinder 50 through the fluid outlet 55.

That is, the fluid supplying device 80 includes various opening/closing valves, and closes the opening/closing valve to cut off the fluid being supplied to the fluid inlet 53. Further, the fluid discharging device 90 includes various opening/closing valves, and opens the opening/closing valve to discharge the fluid from the lift cylinder 50 through the fluid outlet 55.

While the fluid is discharged from the lift cylinder 50, the disc 57 is moved down and the lift stem 40 connecting with the disc and the spring stem 1a connecting with the lift stem 40 are moved down, thereby causing the spring-loaded pilot valve 1 to be closed at some point.

At this time, the controller (not shown) can evaluate whether the spring-loaded pilot valve 1 is closed in the normal re-closing pressure, based on the sensing data related to the force acting on the lift stem 40, the pressure of the lift cylinder 50, the displacement of the disc from various sensors.

For example, it is possible to evaluate the performance of the spring-loaded pilot valve in accordance with whether the re-closing pressure=the system pressure (i.e., use pressure)+(the lift cylinder pressure*the lift cylinder the disc area)/the disc effective area of the spring-loaded pilot valve is within an allowable error range of the normal re-closing pressure.

With the foregoing structures and operations, the POSRV performance evaluation test apparatus controlled according to an exemplary embodiment may include various lift cylinders 50. That is, the lift cylinder 50 according to an exemplary embodiment may be a type of a cylinder or a diaphragm having various sizes. Also, various sizes and kinds of lift cylinder 50 may be used in accordance with the size of the spring-loaded pilot valve 1.

Thus, the kind or sizes of lift cylinder 50 may be varied in order to the setting pressure of the spring-loaded pilot valve 1 having various sizes. In result, there is a need of adjusting a distance between the lower plate 10 and the upper plate 20 in order to easily connect the lift stem 40 and the spring stem 1a.

According to an exemplary embodiment, the frame bar 30 is connected to the lower plate 10 and the upper plate 20 so that the distance between the lower plate 10 and the upper plate 20 can be adjusted.

That is, the frame bar 30 is connected to the upper plate 20 or the lower plate 10 and movable up and down so as to adjust the distance between the upper plate 20 and the lower plate 10.

For example, an upper side of the frame bar 30 is fixed and coupled to the upper plate 20, and a lower side of the frame bar 30 is penetratingly coupled to the lower plate 10 and movable up and down so that the distance between the lower plate 10 and the upper plate 20 can be adjusted.

After adjusting the distance between the lower plate 10 and the upper plate 20, the lower side of the frame bar 30 is fixed not to move as it penetrates the lower plate 10. For example, the lower side of the frame bar 30 may be partially threaded so that the frame bar 30 can be fixed to the lower plate 10 as being fastened with a nut.

Meanwhile, the POSRV performance evaluation test apparatus controlled according to an exemplary embodiment may as shown in FIGS. 1 to 3 include a linear variable differential transformer (LVDT) stem 60. The LVDT stem 60 is vertically coupled to the top surface of the disc 57.

That is, the LVDT stem 60 for measuring the vertical displacement of the disc 57 is installed on the top surface of the disc 57. The LVDT stem 60 measures the displacement of the disc 57, and therefore it can be easily determined whether the spring-loaded pilot valve 1 is opened or closed.

Specifically, the displacement of the disc 57 is increased (varied) while the disc 57 is lifted. If the spring-loaded pilot valve 1 is opened as the disc 57 is lifted to some extent, there is little change in the displacement. That is, there is little displacement of the lifted disc 57 in the state that the spring-loaded pilot valve 1 is opened.

Therefore, the controller determines that the spring-loaded pilot valve 1 is open, when the displacement of the disc 57 sensed by the LVDT stem 60 is little changed (e.g., changed within about ±0.1%), and calculates the foregoing pressure difference through the sensing data received from various sensors.

Meanwhile, during the POSRV performance evaluation according to an exemplary embodiment, that is, while the disc 57 is lifted, there is a need of easily measuring the force acting on the lift stem 40, i.e., the lifting force.

According to an exemplary embodiment, the load cell 70 capable of measuring the lifting force is, as shown in FIG. 3, interposed and connected between the lift stem 40 and the spring stem 1a of the spring-loaded pilot valve 1.

Specifically, the load cell 70 includes one end connected to the lift stem 40 via a first adapter 41, and the other end connected to the spring stem 1a via a second adapter 71. Therefore, the load cell 70 can measure the lifting force while the spring stem 1a is lifted upward.

A value measured in the load cell 70 is input to the controller (not shown), and the controller calculates the foregoing pressure difference by receiving a measured value from the load cell 70 when the spring-loaded pilot valve 1 is opened.

For example, auxiliary force applied by the POSRV performance evaluation test apparatus controlled according to an exemplary embodiment is obtained by (the disc area of the lift cylinder 50)*(the lift cylinder pressure). Further, the setting pressure of the spring-loaded pilot valve 1 is obtained by (the system pressure (i.e., use pressure))+(the pressure difference). Then, the pressure difference is calculated by (the auxiliary force)/(the spring-loaded pilot valve the disc effective area).

Consequently, the pressure difference is calculated by (the measured force of the load cell)/(the spring-loaded pilot valve disc effective area). Based on the setting pressure=the system pressure+(the measured force of the load cell)/(the spring-loaded pilot valve disc effective area), it is possible to evaluate whether the setting pressure of the spring-loaded pilot valve is effective and to evaluate the performance of the POSRV.

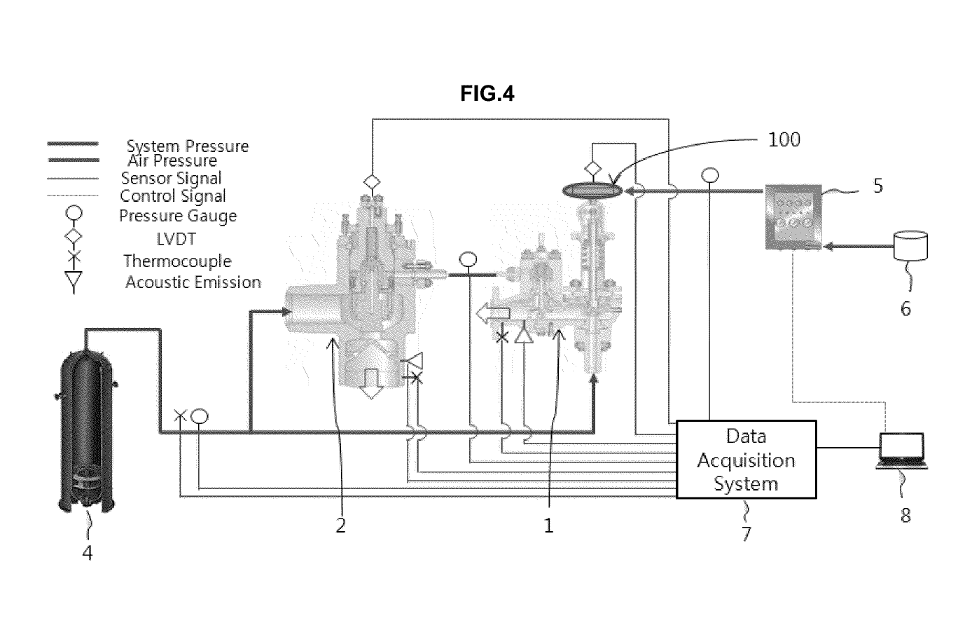

FIG. 4 is a schematic view of a system for testing a setting pressure through the POSRV performance evaluation test apparatus 100 in the state that the spring-loaded pilot valve 1 and the main valve 2 are connected.

As shown in FIG. 4, in the system for testing the setting pressure through the POSRV performance evaluation test apparatus 100, the POSRV performance evaluation test apparatus 100 is connected to the spring-loaded pilot valve 1, the pressurizer 4 is used to apply the system pressure to the spring-loaded pilot valve 1 and the main valve 2, the amount and pressure of fluid supplied from a fluid supplier 6 is adjusted by a fluid adjuster 5 and thus supplied to the lift cylinder of the POSRV performance evaluation test apparatus 100.

With this configuration, it is possible to test the setting pressure. To this end, the data acquisition system 7 collects data sensed by various sensors placed in different parts of the system. Then, the controller 8 determines whether the setting pressure is effective or not, based on the sensing data collected in the data acquisition system 7, thereby evaluating the performance of the spring-loaded pilot valve and the POSRV with the same.

For example, the data acquisition system 7 collects lifting force measured in the load cell installed in the POSRV performance evaluation test apparatus 100, a disc vertical displacement value measured in a displacement sensor provided in the LVDT stem 60, and pressure values measured by pressure sensors respectively provided in fluid supplying lines for supplying the fluid from the lift cylinder and the fluid adjuster 5 to the lift cylinder.

Further, the controller 8 calculates the foregoing pressure difference through various sensing data collected by the data acquisition system 7, and evaluates the performance of the spring-loaded pilot valve 1 and the performance of the POSRV in accordance with whether the sum of the calculated pressure difference and the system pressure is equal to the setting pressure within an allowable error range.

The foregoing POSRV performance evaluation test apparatus controlled according to an exemplary embodiment 100 is driven by a control system 200 for the POSRV performance evaluation test apparatus.

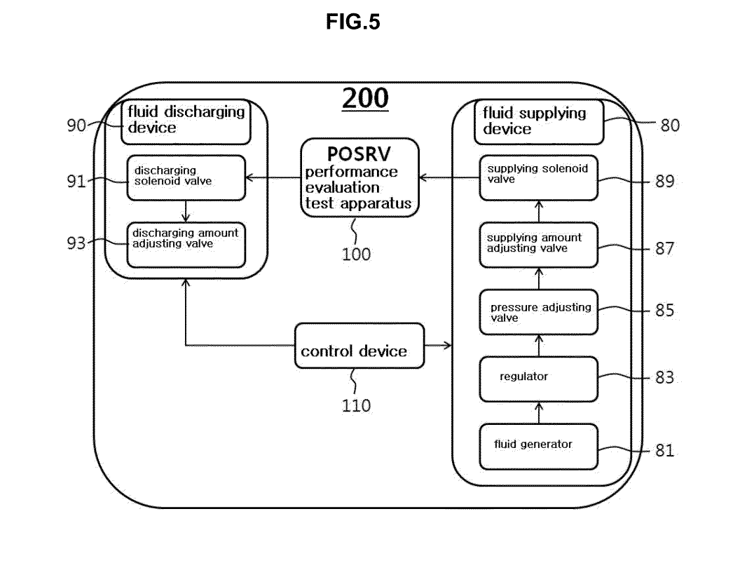

FIG. 5 is a block diagram of the control system 200 for the POSRV performance evaluation test apparatus according to an exemplary embodiment; and

As shown in FIG. 5, the control system 200 for the POSRV performance evaluation test apparatus according to an exemplary embodiment includes the fluid supplying device 80, the fluid discharging device 90 and a control device 110.

The fluid supplying device 80 supplies the fluid into the lift cylinder 50 of the POSRV performance evaluation test apparatus 100 and thus applies the pressure. Under control of the control device 110, the fluid supplying device 80 minutely adjusts only the amount of fluid while constantly keeping the pressure of fluid, or minutely adjusts only the pressure of fluid while constantly keeping the amount of fluid so as to supply the fluid into the lift cylinder 50 and apply the pressure.

That is, the fluid supplying device 80 is controlled by the control device 110 to minutely adjust only the amount of fluid while constantly keeping the pressure of fluid, or minutely adjust only the pressure of fluid while constantly keeping the amount of fluid, thereby supplying the fluid into the lift cylinder 50 and applying the pressure.

Through the fluid supplying device 80, the internal pressure of the lift cylinder 50 is not suddenly applied. Further, the disc 57 is lifted as the fluid supplying device 80 applies the internal pressure of the lift cylinder 50.

The fluid supplying device 80 applies the pressure into the lift cylinder 50 until the spring-loaded pilot valve is opened, that is, until there is no change in the displacement of the lift cylinder 50. No change in the displacement of the lift cylinder 50 can be determined based on the displacement measured by the displacement sensor provided in the LVDT stem 60 for sensing the vertical displacement of the disc 57.

Meanwhile, the fluid discharging device 90 discharges the fluid from the inside of the lift cylinder 50 of the POSRV performance evaluation test apparatus 100 in order to depressurize the inside of the lift cylinder 50. The fluid discharging device 90 serves to depressurize the inside of the lift cylinder 50 under control of the control device 110.

As the fluid discharging device 90 depressurizes the inside of the lift cylinder 50, the disc 57 moves down so that the spring-loaded pilot valve can return to the closed state.

The fluid supplying device 80 and the fluid discharging device 90 operate under control of the control device 110. Specifically, the control device 110 controls only one of the fluid supplying device 80 and the fluid discharging device 90 to operate.

That is, the control device 110 controls the fluid discharging device 90 to stop operating not to discharge the fluid from the lift cylinder 50 while controlling the fluid supplying device 80 to supply the fluid into the lift cylinder 50 and apply the pressure,

On the other hand, the control device 110 controls the fluid supplying device 80 to stop operating to supply the fluid into the lift cylinder 50 and applying the pressure during the depressurization in which the fluid discharging device 90 discharges the fluid from the lift cylinder 50.

The control device 110 controls the fluid supplying device 80 to preferentially operate when driving the POSRV performance evaluation test apparatus. That is, the internal pressure of the lift cylinder 50 is first applied by the fluid supplying device 80.

In this procedure, the displacement of the lift cylinder 50 is varied (e.g., increased). That is, the disc is lifted while the internal pressure of the lift cylinder 50 is increased, thereby changing the displacement of the disc specified by the LVDT stem 60. The change in the displacement of the lift cylinder 50 refers to change in the vertical displacement of the disc.

As the fluid supplying device 80 applies the pressure, the spring-loaded pilot valve will be open at some time. At this time, the displacement of the disc is not changed any more but maintained. That is, the lift cylinder 50 is maintained in the state of no change in the displacement value.

The control device 110 controls the fluid supplying device 80 to stop operating if there is no change in the displacement value of the lift cylinder 50, and then controls only the fluid discharging device 90 to operate.

That is, in the state that the displacement of the lift cylinder 50 is not changed any more, the control device 110 controls the fluid supplying device 80 to stop operating not to apply the pressure to the inside of the lifter cylinder 50, and controls the fluid discharging device 90 to operate so as to depressurize the internal pressure of the lift cylinder 50.

If the fluid discharging device 90 depressurizes the internal pressure of the lift cylinder 50, the spring-loaded pilot valve returns to a closed state again at some point.

In brief, the control device 110 controls only one of the fluid supplying device 80 and the fluid discharging device 90 to operate, in which the fluid supplying device 80 is preferentially controlled to operate, and only the fluid discharging device 90 is then controlled to operate after the fluid supplying device 80 stops operating when there is no change in the displacement value of the lift cylinder 50.

As shown in FIG. 5, the fluid supplying device 80, which supplies the fluid into the lift cylinder 50 and thus applies the pressure under control of the control device 110 until the displacement of the lift cylinder is not changed, includes a fluid generator 81, a regulator 83, a pressure adjusting valve 85, a supplying amount adjusting valve 87 and a supplying solenoid valve 89.

The fluid generator 81 generates and supplies the fluid. That is, the fluid generator 81 generates air, nitrogen, hydraulic pressure, etc. and supplies it to the regulator 83.

The regulator 83 regulates the fluid generated in the fluid generator 81 to have a constant pressure and effuses it. The regulator 83 does not minutely adjust the pressure of the fluid pressure, but effuses the fluid to the pressure adjusting valve 85 at previously setting pressure or pressure regulated under control of the control device 110.

The pressure adjusting valve 85 may keep or minutely adjust the pressure of the fluid regulated by the regulator 83, and effuse it. That is, the pressure adjusting valve 85 receives the fluid having the pressure regulated by the regulator under control of the control device 110, and effuses it directly or at a certain pressure, i.e., a constant pressure or at a regulated pressure.

Here, the effusion of the fluid with changed pressure (i.e., the effusion of the fluid with minutely adjusted pressure) refers to that the introduced fluid is effused with gradually increased pressure. Further, the effusion of the fluid with the maintained pressure refers to that the introduced fluid is continuously effused directly or effused as it is regulated to have only a certain pressure.

Although it will be described later, the pressure adjusting valve 85 minutely adjusts (i.e., changes) the pressure of fluid introduced from the regulator and effuses it in a mode (i.e., a minute pressure adjusting mode) where only the pressure of fluid is changed to apply the pressure to the inside of the lift cylinder while maintaining the amount of fluid under control of the control device 110. On the other hand, the pressure adjusting valve 85 changes the pressure of fluid introduced from the regulator to have a certain pressure and effuses it at a constant static pressure in a mode (i.e., a minute amount adjusting mode) where only the amount of fluid is changed to apply the pressure to the inside of the lift cylinder 50 while maintaining the pressure of fluid under control of the control device 110.

The fluid effused from the pressure adjusting valve 85 is introduced into the supplying amount adjusting valve 87. The supplying amount adjusting valve 87 maintains or minutely adjusts the amount of fluid introduced from the pressure adjusting valve 85 and then effuses it.

That is, the supplying amount adjusting valve 87 receives the fluid introduced from the pressure adjusting valve 85 under control of the control device 110, and effuses it directly or with a certain amount, i.e., a constant amount or a changed amount.

Here, the effusion of the fluid with changed amount (i.e., the effusion of the fluid with minutely adjusted amount) refers to that the introduced fluid is effused with gradually increased amount. Further, the effusion of the fluid with the maintained amount refers to that the introduced fluid is continuously effused directly or effused as it is regulated to have only a certain amount. Also, the change or maintenance of the amount of fluid may refer to that the amount of fluid actually effused through the supplying amount adjusting valve 87 is changed or maintained, or that an opened state of the supplying amount adjusting valve 87 is changed or maintained.

Although it will be described later, the supplying amount adjusting valve 87 maintains the amount of fluid introduced from the pressure adjusting valve 85 (or changes the amount into a certain amount, i.e., a fixed amount) and effuses it in a mode (i.e., a minute amount adjusting mode) where only the pressure of fluid is changed to apply the pressure to the inside of the lift cylinder while constantly maintaining the amount of fluid under control of the control device 110. On the other hand, the supplying amount adjusting valve 87 changes the amount of fluid introduced from the pressure adjusting valve 85 (i.e., gradually increases the amount of fluid) and effuses it in a mode (i.e., a minute amount adjusting mode) where only the amount of fluid is changed to apply the amount to the inside of the lift cylinder 50 while maintaining the pressure of fluid under control of the control device 110.

The fluid effused from the supplying amount adjusting valve 87 is introduced into the supplying solenoid valve 89. Then, the supplying solenoid valve 89 controls the fluid to be supplied from the supplying amount adjusting valve to the lift cylinder 50.

The supplying solenoid valve 89 has to be opened while the fluid is supplied to the lift cylinder 50 and pressurized under control of the control device 110, and has to be closed while the fluid is discharged from the lift cylinder 50 and depressurized.

With the foregoing elements, the fluid supplying device 80 preferentially operates under control of the control device 110, and stops operating in the state that there is no change in the displacement value of the lift cylinder 50. Then, the fluid discharging device 90 operates under control of the control device 110.

The fluid discharging device 90 discharges the fluid from the lift cylinder 50 under control of the control device, thereby depressurizing the inside of the lift cylinder 50. While the fluid discharging device 90 operates, the supplying solenoid valve 89 of the fluid supplying device 80 is already maintained in the closed state under control of the control device. Of course, the other elements constituting the fluid supplying device also stop operating.

As shown in FIG. 5, the fluid discharging device 90 includes a discharging solenoid valve 91 and a discharging amount adjusting valve 93. That is, the fluid discharging device 90 includes the discharging solenoid valve 91 for controlling the fluid to be discharged from the inside of the lift cylinder 50, and the discharging amount adjusting valve 93 adjusting the amount of fluid introduced from the discharging solenoid valve 91 and discharging it.

Under control of the control device 100, the discharging solenoid valve 91 is fully opened to discharge the fluid out of the lift cylinder 50. Then, the fluid is discharged through the discharging solenoid valve 91 as its amount is adjusted by the discharging amount adjusting valve 93.

Here, that the fluid is discharged as the amount of fluid is adjusted by the discharging amount adjusting valve 93 refers to that the introduced fluid is discharged with a certain fixed amount. This may refer to that the actually discharged amount of fluid is the fixed amount, or that the fluid is discharged while the opened state of the discharging amount adjusting valve 93 is fixed.

With the foregoing configurations, the fluid supplying device 80 and the fluid discharging device 90 operates or stops under control of the control device 110. Further, the fluid supplied from the fluid supplying device 80 to the lift cylinder 50 may apply the pressure to the inside of the lift cylinder in the amount minutely-adjusting mode or the pressure minutely-adjusting mode.

Specifically, in the amount minutely-adjusting mode (i.e., the mode where only the amount of fluid is varied while the pressure is constantly maintained so as to apply the pressure to the inside of the lift cylinder), the control device 110 controls the pressure adjusting valve 85 to effuse the fluid with the fixed pressure, and controls the supplying amount adjusting valve 87 to change the amount of fluid introduced at the fixed pressure and effuse it until there is no change in the displacement value of the lift cylinder.

Here, the effusion of the fluid at the fixed pressure refers to that the fluid is effused through the pressure adjusting valve while the pressure of fluid is maintained constantly. Also, no change in the displacement value of the lift cylinder refers to that the spring-loaded pilot valve is opened so that the displacement of the disc cannot be varied any more.

Meanwhile, in the pressure minutely-adjusting mode (i.e., the mode where only the pressure of fluid is varied while the amount is constantly maintained so as to apply the pressure to the inside of the lift cylinder), the control device 110 controls the supplying amount adjusting valve 87 to effuse the fluid with the fixed amount without changing the amount of fluid, and controls the pressure adjusting valve 85 to change the pressure of the fluid introduced at a constant pressure until there is no change in the displacement value of the lift cylinder 50 and effuse it.

Here, the effusion of the fluid with the fixed amount refers to that the amount of fluid effused through the supplying amount adjusting valve is constantly maintained and effused. Further, no change in the displacement value of the lift cylinder the displacement refers to that the spring-loaded pilot valve is opened so that the displacement of the disc cannot be varied any more.

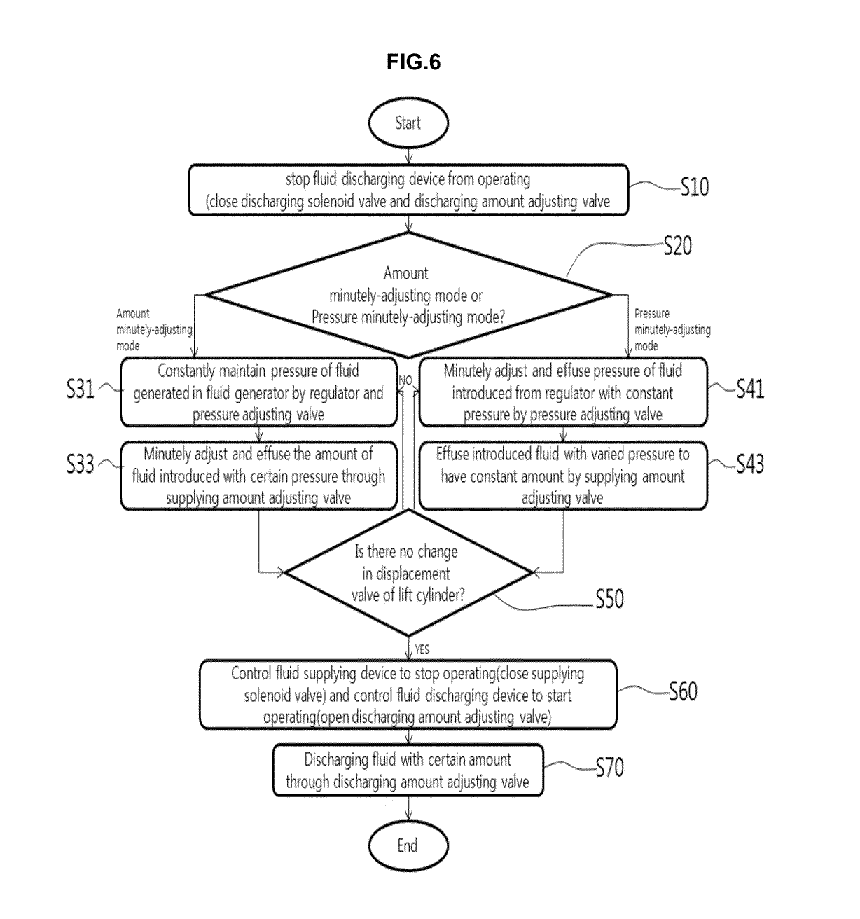

Operations of controlling the foregoing POSRV performance evaluation test apparatus 100 through the control system 200 will be schematically described with reference to FIG. 6.

Many operations described in FIG. 6 are not unchangeable in order, but exchangeable in order each other on the assumption as long as the purpose of the present invention can be achieved. For example, it is possible to achieve the same purpose even though the order of operations S10 and S20 in FIG. 6 may be changed.

First, the control device 110 controls the fluid discharging device 90 to stop operating. That is, it is controlled that the fluid is not discharged from the lift cylinder 50 through the fluid discharging device 90. Therefore, the discharging solenoid valve 91 of the fluid discharging device 90 is maintained in the closed state. Of course, the discharging amount adjusting valve 93 may also be maintained in the closed state (S10).

Next, the control device 110 determines whether to operate the fluid supplying device 80 in the amount minutely-adjusting mode or the pressure minutely-adjusting mode (S20). Such a mode may be previously determined, or determined or changed by a user, or arbitrarily determined by the control device 110.

If the fluid supplying device 80 operates in the amount minutely-adjusting mode, the control device 110 controls the fluid supplying device 80 to change and adjust the amount of fluid while maintaining the pressure of fluid and supply it to the lift cylinder for pressurization.

Specifically, under control of the control device, the pressure of fluid generated in the fluid generator 81 is constantly regulated and maintained by the regulator 83 and the pressure adjusting valve 85, thereby effusing it to the supplying amount adjusting valve 87 (S31). That is, the regulator regulates the introduced fluid to have a certain pressure and effuses it, and the pressure adjusting valve effuses the fluid with the regulated pressure directly or with only a certain pressure.

Then, the supplying amount adjusting valve 87 minutely adjusts the amount of fluid with the certain pressure and then effuses it (S33). That is, the supplying amount adjusting valve gradually increases the amount of fluid introduced under control of the control device and supplies it to the inside of the lift cylinder. At this time, the supplying solenoid valve 89 is naturally maintained in the opened state.

Thus, if the supplying amount adjusting valve 87 applies the pressure to the inside of the lift cylinder while changing the amount of fluid, the disc is lifted and becomes a state where there is no change in the displacement at some time.

Meanwhile, if the fluid supplying device 80 operates in the pressure minutely-adjusting mode, the control device 110 controls the fluid supplying device 80 to change the pressure of fluid while the amount of fluid is constantly maintained and supply it to the lift cylinder for pressurization.

Specifically, under control of the control device, the fluid generated by the fluid generator is regulated by the regulator to have a constant pressure, and then effused. Then, the pressure adjusting valve minutely adjusts the pressure of fluid introduced from the regulator with the constant pressure and effuses it (S41).

That is, the pressure adjusting valve adjusts and effuses the fluid so that the pressure of intruded fluid can be gradually increased. Then, the fluid of which pressure is continuously varied is introduced into the supplying amount adjusting valve.

The supplying amount adjusting valve effuses the introduced fluid with varied pressure to have a constant amount (S43). In result, the amount of fluid supplied into the lift cylinder is constant, while the pressure of fluid is gradually increased. Therefore, the disc is changed in the displacement. At some point, the disc is maintained in the state where the displacement is not changed any more.

As described above, in the amount minutely-adjusting mode or the pressure minutely-adjusting mode, the internal pressure of the lift cylinder is gradually increased and at some point there is no change is the displacement value of the lift cylinder.

Therefore, the control device 110 checks whether there is no change in the displacement value of the lift cylinder, and repeats the operations S31 and S33 or the operations S41 and S43 if there is the change (S50).

In the case where there is no change in the displacement value of the lift cylinder, the spring-loaded pilot valve is opened and therefore the displacement of the disc is not changed.

At this time, the control device controls the fluid supplying device to stop operating and controls the fluid discharging device to start operating (S60). Specifically, the control device controls the supplying solenoid valve of the fluid supplying device to be closed, and controls the discharging solenoid valve and the discharging amount adjusting valve of the fluid discharging device to be opened.

Then, the fluid is discharged from the lift cylinder through the supplying solenoid valve, in which the fluid is discharged with a certain amount through the discharging amount adjusting valve (S70).

When the fluid is discharged from the lift cylinder by the fluid discharging device, the lift cylinder is depressurized and consequently the spring-loaded pilot valve is maintained in the re-closing state at some point.

In the POSRV performance evaluation test apparatus according to an exemplary embodiment, the lift cylinder internally provided with the disc to be lifted by introduction of the fluid is attached to the upper plate, and it is thus possible to perform a precise test under a structurally stable condition. Further, the space between the upper plate and the lower plate is adjustable, and it is thus possible to cope with various sizes of the spring-loaded pilot valve or the lift cylinder. Also, the load cell is interposed between the lift stem and the spring stem, and it is thus possible to effectively measure the force acting on the lift stem or the pressure applied to the lift cylinder.

In the control system for the POSRV performance evaluation test apparatus according to an exemplary embodiment, the inside of the lift cylinder is pressurized by minutely adjusting the amount of fluid with the constant pressure or by minutely adjusting the pressure of fluid with the constant amount, so that the inside of the lift cylinder can be prevented from being suddenly pressurized, thereby preventing the lift cylinder from damage and at the same time allowing the performance of the POSRV to be more precisely evaluated by precisely measuring the setting pressure of the spring-loaded pilot valve.

Also, in the control system for the POSRV performance evaluation test apparatus according to an exemplary embodiment, the fluid can be discharged with a constant amount from the lift cylinder, so that the inside of the lift cylinder can be prevented from being suddenly depressurized, thereby preventing the lift cylinder and the spring-loaded pilot valve from damage and at the same time allowing the performance of the POSRV to be more precisely evaluated by precisely measuring the re-closing pressure of the spring-loaded pilot valve.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

1. A pilot operated safety and relief valve (POSRV) performance evaluation test apparatus comprising:
a lower plate which is installed in an upper portion of a spring-loaded pilot valve;
an upper plate which is placed above and opposite in parallel to the lower plate;
a frame bar which connects the lower plate and the upper plate;
a lift cylinder which is fixed and attached to a bottom of the upper plate and comprises an inner space where a disc is lifted by fluid introduced from an outside; and
a lift stem which comprises one end connected to a bottom of the disc and the other end vertically extended downward and connected to a spring stem of the spring-loaded pilot valve as being exposed to the outside of the lift cylinder.

2. The POSRV performance evaluation test apparatus according to claim 1, wherein the lift cylinder comprises a coupling plate attached and coupled to the bottom of the upper plate, and a cylinder shell which comprises an upper portion attached to the coupling plate to form the inner space, in which the disc is arranged at an upper side, a fluid inlet and a fluid outlet through which the fluid can be introduced and discharged at lateral lower sides, respectively, and a through hole to be penetrated by the lift stem on a bottom.

3. The POSRV performance evaluation test apparatus according to claim 1, wherein the frame bar is coupled to the upper plate or the lower plate and movable up and down to adjust a distance between the upper plate and the lower plate.

4. The POSRV performance evaluation test apparatus according to claim 1, further comprising a linear variable differential transformer (LVDT) stem which is installed on a top of the disc and measures a vertical displacement of the disc.

5. The POSRV performance evaluation test apparatus according to claim 1, further comprising a load cell interposed and connected between the lift stem and the spring stem of the spring-loaded pilot valve.

6. A control system of a pilot operated safety and relief valve (POSRV) performance evaluation test apparatus, the control system comprising:
a fluid supplying device which supplies fluid into and applies pressure to a lift cylinder of the POSRV performance evaluation test apparatus by minutely adjusting only an amount of fluid while constantly maintaining a pressure of fluid or by minutely adjusting only the pressure of fluid while constantly maintaining the amount of fluid;
a fluid discharging device which discharges the fluid from the lift cylinder of the POSRV performance evaluation test apparatus to depressurize the inside of the lift cylinder; and
a control device which controls only one of the fluid supplying device and the fluid discharging device, in which the fluid supplying device is controlled to preferentially operate, and only the fluid discharging device is controlled to operate after controlling the fluid supplying device to stop operating when there is no change in a displacement value of the lift cylinder.

7. The control system according to claim 6, wherein the fluid supplying device comprises a fluid generator which generates and supplies the fluid; a regulator which regulates and effuses the fluid generated by the fluid generator to have a certain pressure; a pressure adjusting valve which maintains or minutely adjusts the regulated pressure of fluid to be effused; a supplying amount adjusting valve which maintains or minutely adjusts the amount of fluid introduced from the pressure adjusting valve and effused; and a supplying solenoid valve which controls the fluid introduced from the supplying amount adjusting valve to be supplied to the lift cylinder.

8. The control system according to claim 7, wherein the fluid discharging device comprises a discharging solenoid valve which controls the fluid to be discharged from the lift cylinder; and a discharging amount adjusting valve which adjusts the amount of fluid introduced from the discharging solenoid valve to be discharged.

9. The control system according to claim 7, wherein the control device controls the pressure adjusting valve to effuse the fluid with a fixed pressure, and controls the supplying amount adjusting valve to effuse the fluid with the fixed pressure while changing the amount of fluid until there is no change in a displacement value of the lift cylinder.

10. The control system according to claim 7, wherein the control device controls the supplying amount adjusting valve to effuse the introduced fluid with a fixed amount without changing the amount of fluid, and controls the pressure adjusting valve to effuse the fluid introduced with a certain pressure while changing the pressure of fluid until there is no change in the displacement value of the lift cylinder.

11. The POSRV performance evaluation test apparatus according to claim 2, further comprising a load cell interposed and connected between the lift stem and the spring stem of the spring-loaded pilot valve.

12. The POSRV performance evaluation test apparatus according to claim 3, further comprising a load cell interposed and connected between the lift stem and the spring stem of the spring-loaded pilot valve.

13. The POSRV performance evaluation test apparatus according to claim 4, further comprising a load cell interposed and connected between the lift stem and the spring stem of the spring-loaded pilot valve.

14. The control system according to claim 8, wherein the control device controls the pressure adjusting valve to effuse the fluid with a fixed pressure, and controls the supplying amount adjusting valve to effuse the fluid with the fixed pressure while changing the amount of fluid until there is no change in a displacement value of the lift cylinder.

15. The control system according to claim 8, wherein the control device controls the supplying amount adjusting valve to effuse the introduced fluid with a fixed amount without changing the amount of fluid, and controls the pressure adjusting valve to effuse the fluid introduced with a certain pressure while changing the pressure of fluid until there is no change in the displacement value of the lift cylinder.
